(19) United States
(12) Patent Application Publication
(10) Pub. No.: US 2007/0051827 A1
(43) Pub. Date: Mar. 8, 2007

(54) Spraying device

(76) Inventors: Sheng-Chih Shen, Sinying City (TW); Yu-Ran Wang, Bangiao City (TW); Tai-Feng Wu, Yongkang City (TW); Rung-Sheng Cheng, Siluo Township (TW); Chi-Hsiung Teng, Sinjhuang City (TW)

Correspondence Address: PRO-TECHTOR INTERNATIONAL SERVICES, 20775 NORADA CT., SARATOGA, CA, 95070, US

(21) Appl. No.: 11/286,668

(22) Filed: Nov. 25, 2005

(30) Foreign Application Priority Data
Sep. 8, 2005 (TW) 094130829

(51) Int. Cl. B05B 1/08

(52) U.S. Cl. 239/102.2; 239/548; 239/596

(57) ABSTRACT

A mist generating apparatus comprises a case, having a chamber, an inlet and an opening, an auxiliary vibrating element, mounted in said opening of said case and having a central hole and a periphery, a vibrating element, connected with said vibrating element at said periphery thereof and having an electrode and a connecting wire, and a spraying plate, having a plurality of spraying holes, set on said central hole of said auxiliary vibrating element, wherein said vibrating element generates vibrations which are transmitted to said auxiliary vibrating element, being enhanced by a projecting part thereof, then further transmitted to said spraying plate, so that liquid in said chamber is pressed through said spraying holes and mist is generated, while manufacturing cost is reduced, spraying effectivity is enhanced, noise is reduced, and lifetime is enhanced.

### BACKGROUND OF THE INVENTION

1. Field of the Invention

The present invention relates to a mist generating apparatus and method, particularly to a mist generating apparatus which uses vibrating piezoelectric material to generate pressure variations that disperse liquid through tiny holes, while having reduced manufacturing cost, increased effectivity of spraying, less noise and increased lifetime.

2. Description of Related Art

Currently available vibrating devices are produced in two kinds. The first kind of vibrating devices operates with large pressure differences, allowing to disperse large particles. Disadvantages of these devices are large noise and high manufacturing cost. The second kind of vibrating devices uses ultrasound to disperse liquid into small droplets which are sprayed. Shortcomings of these devices are high electric power consumption, the need for fans to spray dispersed droplets into a preferred direction, large volumes and non-uniform sizes of sprayed droplets.

Among piezoelectric spraying devices, besides devices with high noise mentioned above, there are devices which each have a spraying plate 90, as shown in FIGS. 6a and 6b. The spraying plate 90 has a central projecting part 91 with a plurality of spraying holes 92. Thereby, electric power consumption is greatly reduced and sizes of sprayed particles are controlled by diameters of the spraying holes.

Related current patents are of two kinds. In the first, piezoelectric material is used to press liquid through the spraying plate 90, generating mist. In the second kind, the spraying plate 90 vibrates, driven by piezoelectric material, so that liquid is driven through the spraying holes 92 and dispersed. Piezoelectric sprayers of the first kind require relatively large power for generating droplets of small sizes and are thus less efficient than those of the second kind.

However, the spraying plate contributes to a relatively large part of costs, about 30%. Therefore, a smaller effective area of the spraying plate, while maintaining the spraying effect, will lead to lower cost and better usability. Furthermore, spraying plates made of electroplated cast nickel and copper have relatively low resonance frequencies, leading under certain conditions to an unpleasant noise during operation, which makes the spraying device unsuitable for medical applications.

Referring again to FIGS. 6a and 6b, the spraying plate 90, being made of electroplated cast material, is very thin, about 30 μm, so that the projecting part 91 easily deforms or even breaks, hampering the effect of the spraying holes 92.

U.S. Pat. No. 4,605,167 “Ultrasonic Liquid Ejecting Apparatus” discloses a spraying device having a projecting spraying plate with a large area. Its disadvantages are high manufacturing cost due to working the projecting spraying plate; high consumption of liquid upon frequent use; large noise during ejection of liquid.

U.S. Pat. No. 5,518,179 “Fluid Droplet Production Apparatus and Method” discloses a spraying device without a projection having a large area. Its disadvantages are high operating cost; low spraying effectivity; large noise during ejection of liquid.

Due to the shortcomings of conventional art, there is a need to provide an improved spraying device.

### SUMMARY OF THE INVENTION

It is the object of the present invention to provide a mist generating apparatus and method with low manufacturing cost, high spraying effectivity, low noise and long lifetime.

The present invention can be more fully understood by reference to the following description and accompanying drawings.

### DETAILED DESCRIPTION OF THE PREFERRED EMBODIMENTS

As shown in FIGS. 1-3, the mist generating apparatus of the present invention comprises: a case 10, housing liquid; a carrier ring 20 for carrying structural parts; a vibrating element 30, generating vibrations; an auxiliary vibrating element 40 for enhancing the amplitude of generated vibrations, which is either a flat body or has an inclined surface 401 or has a surface with steps; and a spraying plate 50 having a plurality of spraying holes 51. During usage, vibrations generated by the vibrating element 30 are transmitted to the auxiliary vibrating element 40, causing vibrations thereof, so that via the spraying plate 50 pressure is exerted on liquid in the case 10, causing liquid to be pressed through the spraying holes 51 and to be sprayed as mist. In the following, a detailed description is given.

The case 10 has a chamber 11 for accommodating liquid, an inlet for filling the chamber 11 with liquid, and an opening 13.

The carrier ring 20 is made of soft material, preventing leaking of liquid, and is mounted in the opening 13 of the case 10, having a central opening 21.

The vibrating element 30 is made of piezoelectric material and surrounded by the carrier ring 20 to avoid direct contact with liquid, having an electrode 31 and a connecting wire 32, contacting the electrode 31.

The auxiliary vibrating element 40 has a central hole 41 and touches the vibrating element 30 at a periphery, which is surrounded by the carrier ring 20.

The spraying plate 50 with the plurality of spraying holes 51 is set on the auxiliary vibrating element 40.

During operation, an electric current passes through the connecting wire 32 and the electrode 31, reaching the vibrating element 30. Vibrations generated by the vibrating element 30 are transmitted to the auxiliary vibrating element 40 and on to the spraying plate 50. Thereby pressure is exerted on liquid in the chamber 11, causing liquid to be pressed through the spraying holes 51 and to be sprayed as mist. As shown in FIGS. 1-3, the auxiliary vibrating element 40 vibrates inside liquid in the chamber 11.

Referring to FIG. 2a, in a second embodiment of the present invention, the auxiliary vibrating element 40 is mounted in the opening 13 of the case 10, having the central hole 41. The vibrating element 30 is set on a periphery of the auxiliary vibrating element 40, having the electrode 31 and the connecting wire 32.

Referring to FIG. 2b, in a third embodiment of the present invention, the inclined surface 401 of the auxiliary vibrating element 40 extends to outside of the chamber 11.

For using the mist generating apparatus as a portable device, the chamber 11 is enlarged according to demand, e.g., to be taken along and used by a patient. For generating humidity over an extended time or for watering plants, a water source is connected to the inlet 12, allowing for an uninterrupted supply of water.

Referring to FIGS. 4a-4b, the spraying plate 50 has a periphery that is fixed on the auxiliary vibrating element 40, which, as compared to conventional art shown in FIGS. 6a-6b, allows for reducing the area of the spraying plate 50, greatly saving cost. By providing the auxiliary vibrating element 40 with a projecting shape, the spraying plate oscillates with an enlarged amplitude, so that mist generation is enhanced.

Furthermore, the auxiliary vibrating element 40 and the spraying plate 50 are separate parts, with the auxiliary vibrating element 40 manufactured by punching and the spraying plate 50 by MEMS. Therefore, a small area of the spraying plate 50 is possible, reducing manufacturing cost. Moreover, deforming of the spraying holes 51 by falling on the auxiliary vibrating element 40 is avoided, and the auxiliary vibrating element 40 has a thickness that is variable, allowing to compensate for deformations during working. Stiff steel material is used for the auxiliary vibrating element 40, resulting in a higher resonance frequency and stability, so that operating noise is reduced and lifetime is extended.

Referring to FIGS. 5a-5c, the inner hole 41 of the auxiliary vibrating element 40 has an inner wall 41a, 41b, 41c with a cross-section having a step, trapezoidal or inclined shape, respectively.

Referring to FIGS. 5d-5f, the auxiliary vibrating element 40 has a projecting part 42a, 42b, 42c which is curved like the letter S, concave or convex, respectively, for maximizing the oscillating amplitude of the spraying plate 50.

As above explanation shows, the present invention offers the following advantages:

1. Cost of the spraying plate is reduced.

2. Spraying effectivity is enhanced.

3. Operating noise is reduced.

4. Stability is increased, resulting in a longer lifetime.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is an exploded perspective view of the mist generating apparatus of the present invention.

FIG. 2 is a sectional side view of the mist generating apparatus of the present invention.

FIG. 2a-2b are sectional side views of the present invention in the second and third embodiments.

FIG. 3 is a schematic illustration of oscillations of the auxiliary vibrating element.

FIGS. 4a-4b are schematic illustrations of assembling the auxiliary vibrating element and the spraying plate.

FIGS. 5a-5f are schematic illustrations of various embodiments of the auxiliary vibrating element.

FIGS. 6a-6b are schematic illustrations of a conventional mist generating apparatus.

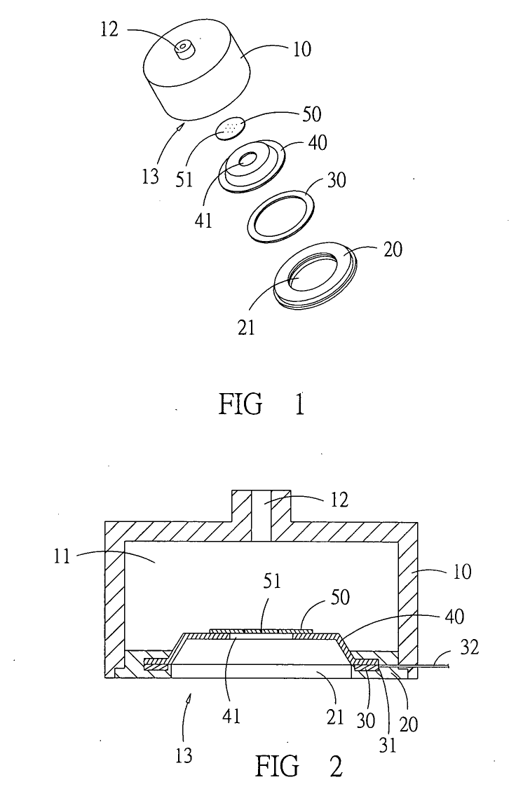

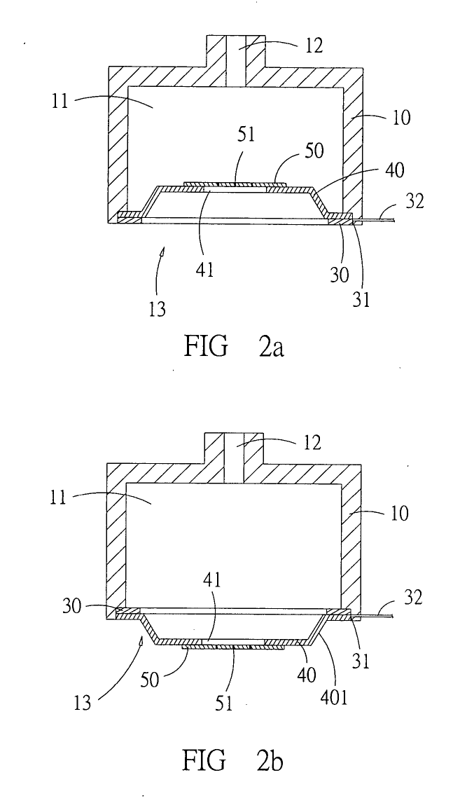

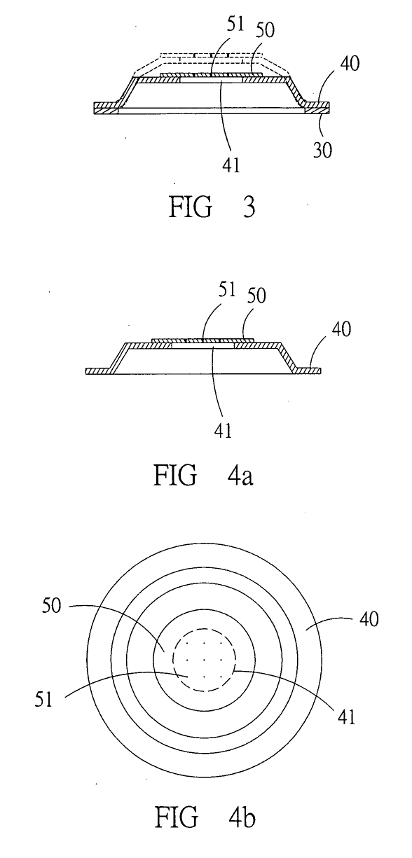

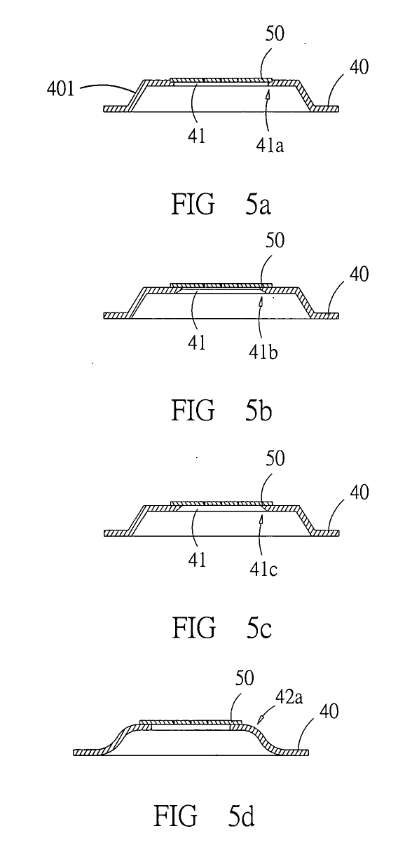

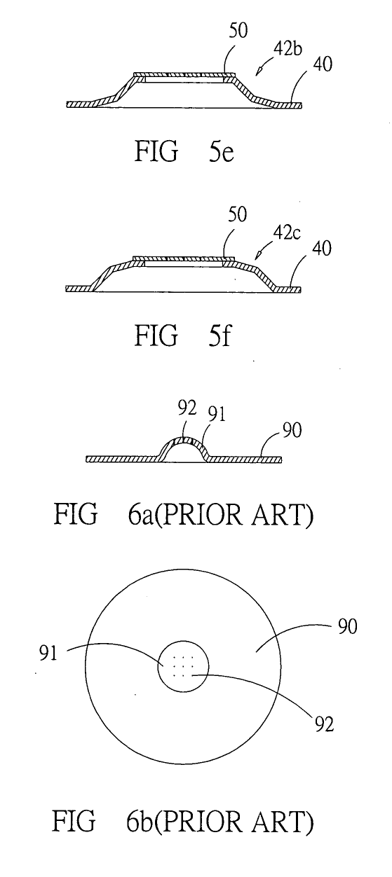

1. A mist generating apparatus, comprising:
a case, having a chamber, an inlet and an opening;
an auxiliary vibrating element, mounted in said opening of said case and having a central hole and a periphery;
a vibrating element, connected with said vibrating element at said periphery thereof and having an electrode and a connecting wire; and
a spraying plate, having a plurality of spraying holes, set on said central hole of said auxiliary vibrating element;
wherein said vibrating element generates vibrations which are transmitted to said auxiliary vibrating element, being enhanced by a projecting part thereof, then further transmitted to said spraying plate, so that liquid in said chamber is pressed through said spraying holes and mist is generated.

2. The mist generating apparatus according to claim 1, wherein said auxiliary vibrating element is a flat plate or has an inclined surface or a surface with a step.

3. The mist generating apparatus according to claim 1, wherein said carrier ring is made of soft material.

4. The mist generating apparatus according to claim 1, wherein said vibrating element is made of piezoelectric material.

5. The mist generating apparatus according to claim 1, wherein said auxiliary vibrating element is made of steel material.

6. The mist generating apparatus according to claim 1, wherein said central hole of said auxiliary vibrating element has an inner wall with a trapezoidal cross-section.

7. The mist generating apparatus according to claim 1, wherein said central hole of said auxiliary vibrating element has an inner wall with an inclined cross-section.

8. The mist generating apparatus according to claim 1, wherein said auxiliary vibrating element has a projecting part with a cross-section which is curved like the letter S.

9. The mist generating apparatus according to claim 1, wherein said auxiliary vibrating element has a projecting part with a concave cross-section.

10. The mist generating apparatus according to claim 1, wherein said auxiliary vibrating element has a projecting part with a convex cross-section.

11. The mist generating apparatus according to claim 1, wherein said auxiliary vibrating element is held by a carrier ring fastened to said case.

12. The mist generating apparatus according to claim 1, wherein said projecting part extends to outside of said chamber.
